(19) United States
(12) Patent Application Publication
(10) Pub. No.: US 2026/0290015 A1
(43) Pub. Date: Sep. 24, 2026

(54) SYSTEMS AND METHODS FOR EVENT-BASED LOCATION CONTROL

(71) Applicant: Resideo USA LLC, Golden Valley, MN (US)

(72) Inventors: Brett Vandenbussche, Minneapolis, MN (US); Christopher Jones, Minneapolis, MN (US); Peter Anderholm, New Harbor, ME (US)

(73) Assignee: Resideo USA LLC, Golden Valley, MN (US)

(21) Appl. No.: 19/673,020

(22) Filed: May 11, 2026

Related U.S. Application Data
(63) Continuation of application No. PCT/US2024/059505, filed on Dec. 11, 2024.
(60) Provisional application No. 63/609,611, filed on Dec. 13, 2023.

(51) Int. Cl. G06V 20/40; G05B 15/02

(52) U.S. Cl. CPC G06V 20/44; G05B 15/02; G06V 20/41

(57) ABSTRACT

Disclosed are systems and methods that provide a novel framework for automatically and dynamically leveraging learned patterns at a location against current spatial, temporal, logical and current event data at the location to control the location and/or devices operating therein. The framework is configured for implementation within location monitoring systems (e.g., climate control and/or security monitoring systems), which enable the real-time, proactive control and management of a location. The framework can detect, via collected sensor data, upcoming and/or current weather-related events, and proactively execute operations that configure, modify and/or secure the location against dangers associated with such events.

### CROSS-REFERENCED APPLICATION

This application is a continuation application of PCT International Application No. PCT/US2024/059505, filed Dec. 11, 2024, which claims priority to and the benefit of U.S. Provisional Patent Application No. 63/609,611, filed Dec. 13, 2023, the contents of each of which are incorporated herein by reference in their entireties.

### FIELD OF THE DISCLOSURE

The present disclosure is generally related to a location monitoring and control system, and more particularly, to a decision intelligence (DI)-based computerized framework for automatically and dynamically leveraging learned patterns at a location against current spatial, temporal, logical and current event data at the location to control the location and/or devices operating therein

### BACKGROUND

Conventional mechanisms for location monitoring systems for reacting to current weather events are tied to alerting users to predicted or current events, which enable them to act accordingly. For example, if rain is in the forecast, a user may receive an alert on their smart phone, which can cause them to close the window, entirely at their discretion.

### SUMMARY OF THE DISCLOSURE

According to some embodiments, the disclosed systems and methods provide a novel computerized framework for location monitoring systems (e.g., climate control and/or security monitoring systems, for example), which enable the real-time, proactive control and management of a location (e.g., a home, office, or other type of building, structure or dwelling in which climate control/security systems are deployed therein). According to some embodiments, sensor data associated with the climate control system and/or security management system associated with the location can be analyzed, upon which the framework can detect upcoming and/or current weather-related events, and proactively execute operations that configure, modify and/or secure the location against dangers associated with such events.

By way of a non-limiting example, the disclosed systems and methods can monitor doorbell camera footage from the front door of a home, and determine that a thunderstorm is moving in the direction of the home (e.g., headed southwest at 5 MPH). Such determination can be performed by performing an artificial intelligence/machine learning (AI/ML) based analysis of the captured image frames (or video clip(s)) from the doorbell camera. Accordingly, as discussed below in more detail, the disclosed framework can cause a controller of the location monitoring system to secure the home. For example, if windows are detected as being opened, they can be closed; if blinds are open, they can be closed; doors locked (e.g., front door, garage doors, for example); water can be turned off (so as to prevent people from showering during the storm); and the like, or some combination thereof.

By way of another non-limiting example, if the captured sensor data indicates that it is sunny outside, and/or the UV index is at or above a threshold (e.g., clear skies as confirmed from analysis of the image frames of a doorbell camera), the disclosed framework can effectuate/cause controls to close/draw the blinds/shades on the windows of the home that are currently facing the sun, and have the shades projected to be in the path of the setting sun be closed as the sun sets.

According to some embodiments, a method is disclosed for a DI-based computerized framework for automatically and dynamically leveraging learned patterns at a location against current spatial, temporal, logical and current event data at the location to control the location and/or devices operating therein. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for automatically and dynamically leveraging learned patterns at a location against current spatial, temporal, logical and current event data at the location to control the location and/or devices operating therein.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates an exemplary workflow according to some embodiments of the present disclosure;

FIG. 5 depicts a non-limiting example implementation according to some embodiments of the present disclosure;

FIG. 6 depicts an exemplary implementation of an architecture according to some embodiments of the present disclosure;

FIG. 7 depicts an exemplary implementation of an architecture according to some embodiments of the present disclosure; and

FIG. 8 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

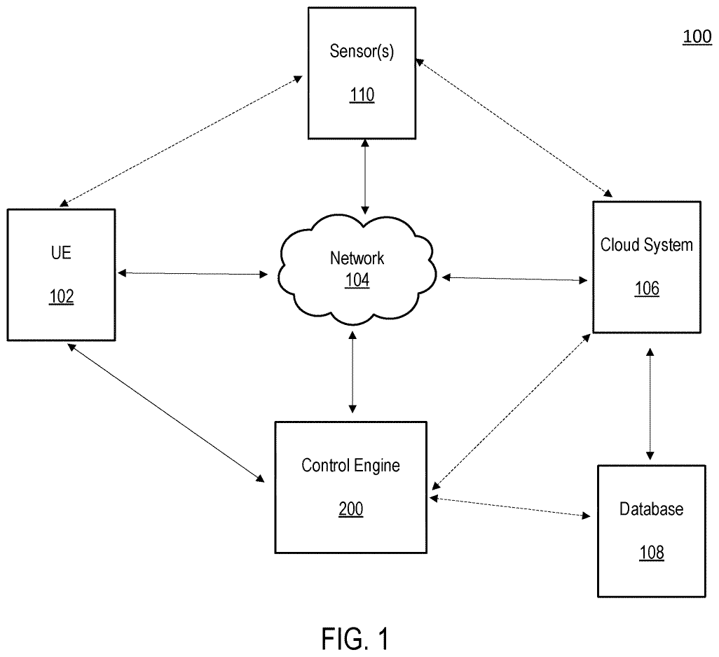

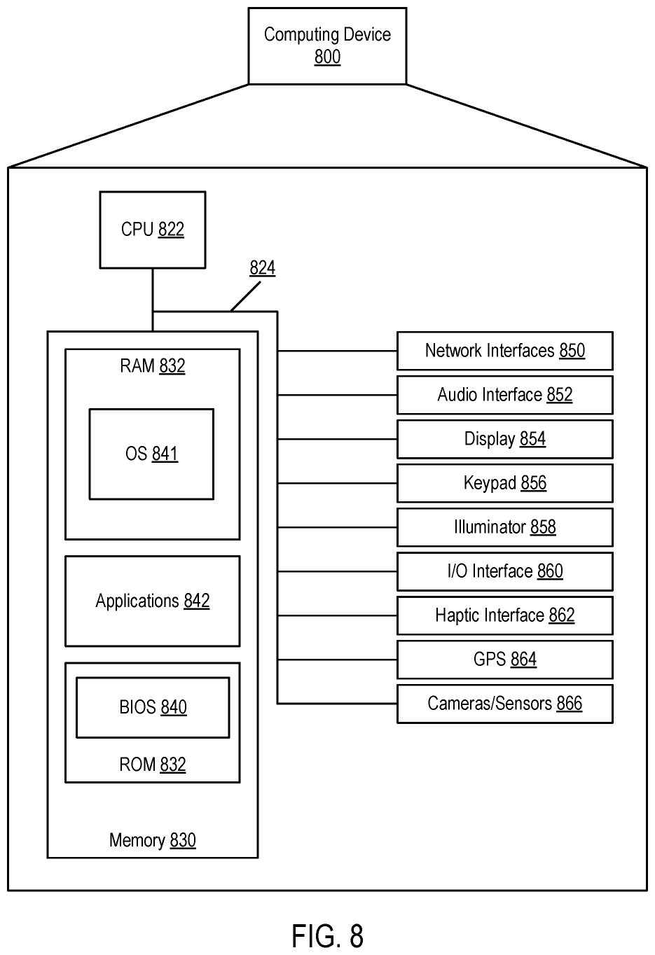

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 8), network 104, cloud system 106, database 108, sensors 110 and control engine 200. It should be understood that while system 100 is depicted as including such components, it should not be construed as limiting, as one of ordinary skill in the art would readily understand that varying numbers of UEs, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, smart television (TV) Internet of Things (IoT) device, autonomous machine, wearable device, and/or any other device equipped with a cellular or wireless or wired transceiver. For example, UE 102 can be a thermostat for a climate control system at a location (e.g., a home, for example).

In some embodiments, a peripheral device (not shown) can be connected to UE 102, and can be any type of peripheral device, such as, but not limited to, a wearable device (e.g., smart watch), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

According to some embodiments, sensors 110 (or sensor devices 110) can correspond to any type of device, component and/or sensor associated with a location of system 100 (referred to, collectively, as “sensors”). In some embodiments, the sensors 110 can be any type of device that is capable of sensing and capturing data/metadata related to a user and/or activity of the location. For example, the sensors 110 can include, but not be limited to, cameras, motion detectors, door and window contacts, temperature, heat and smoke detectors, passive infrared (PIR) sensors, time-of-flight (ToF) sensors, and the like. In some embodiments, the sensors 110 can be associated with devices associated with the location of system 100, such as, for example, lights, smart locks, garage doors, smart appliances (e.g., thermostat, refrigerator, television, personal assistants (e.g., Alexa®, Nest®, for example)), smart rings, smart phones, smart watches or other wearables, tablets, personal computers, and the like, and some combination thereof. For example, the sensors 110 can include the sensors on UE 102 (e.g., smart phone) and/or peripheral device (e.g., a paired smart watch).

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a location monitoring and control system provider (e.g., climate control system and/or security system provided by Resideo®, for example), which has associated network resources hosted on the internet or private network (e.g., network 104), which enables (via engine 200) the location management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, sensors 110, and the services and applications provided by cloud system 106 and/or control engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

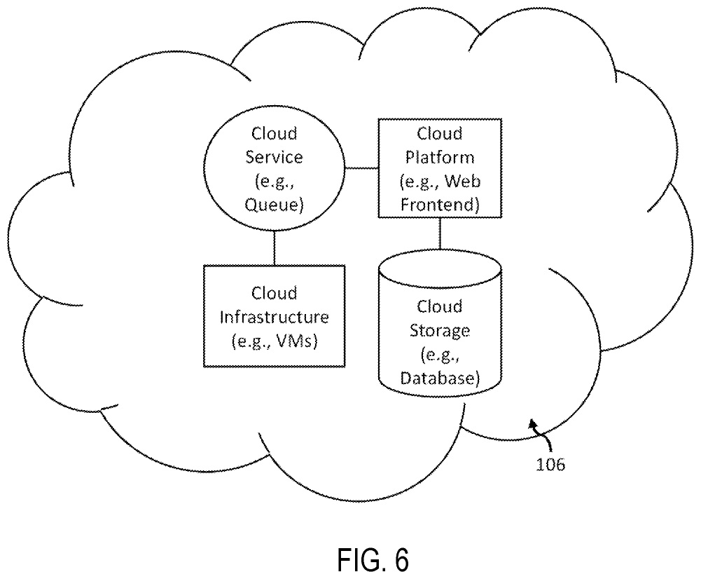

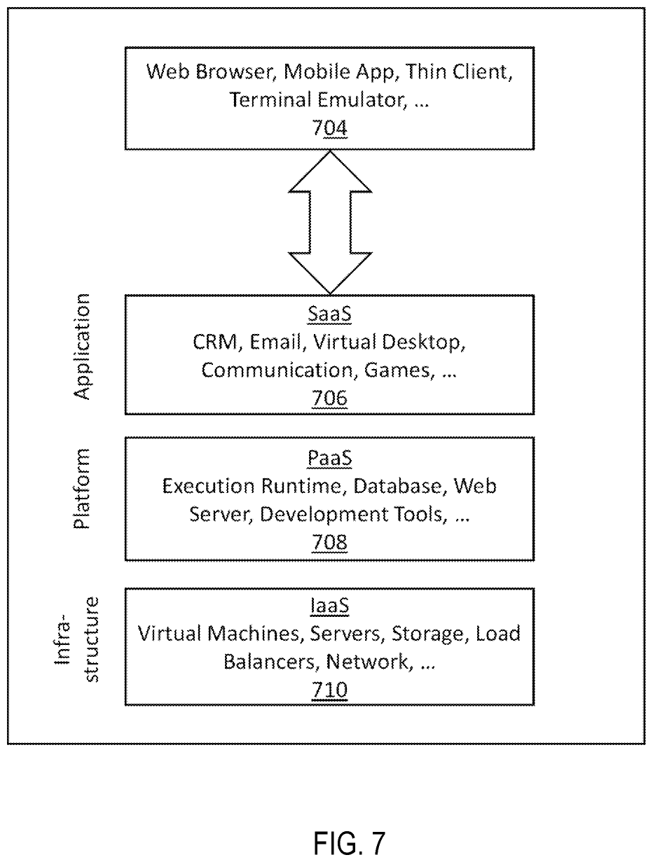

Turning to FIG. 6 and FIG. 7, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 710, platform as a service (PaaS) 708, and/or software as a service (Saas) 706 using a web browser, mobile app, thin client, terminal emulator or other endpoint 704. FIG. 6 and FIG. 7 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Control engine 200, as discussed above and further below in more detail, can include components for the disclosed functionality. According to some embodiments, control engine 200 may be a special purpose machine or processor, and can be hosted by a device on network 104, within cloud system 106 and/or on UE 102. In some embodiments, engine 200 may be hosted by a server and/or set of servers associated with cloud system 106.

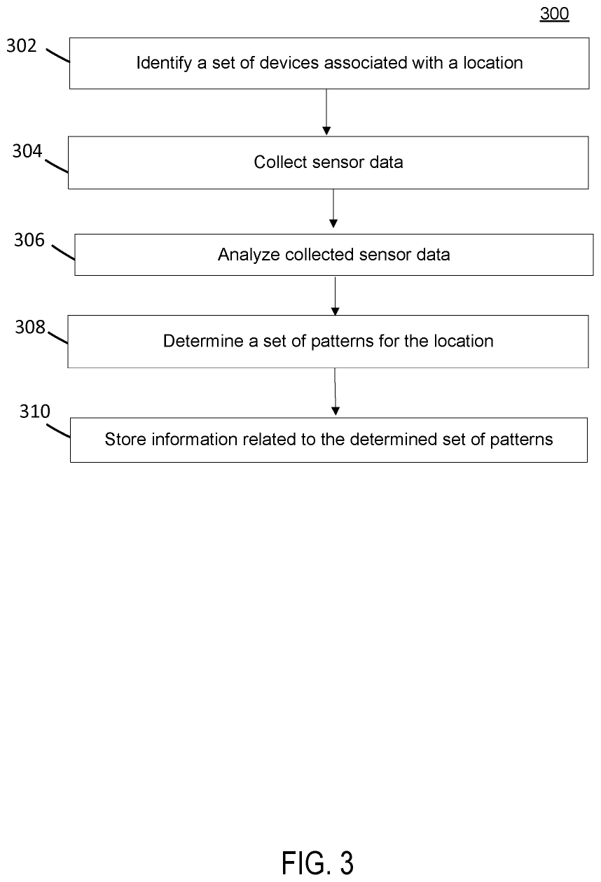

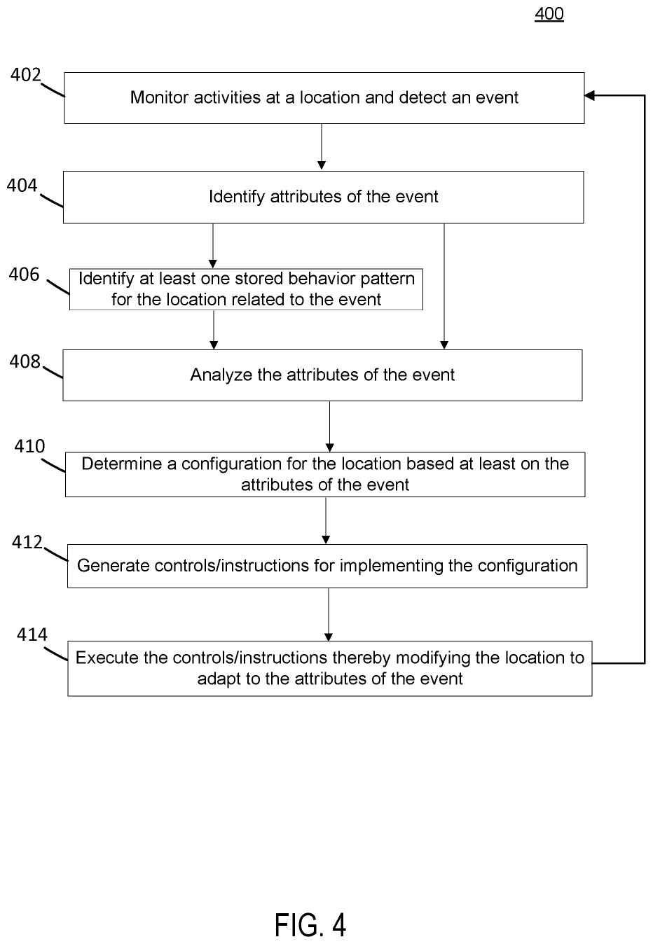

According to some embodiments, as discussed in more detail below, control engine 200 may be configured to implement and/or control a plurality of services and/or microservices, where each of the plurality of services/microservices are configured to execute a plurality of workflows associated with performing the disclosed device management. Non-limiting embodiments of such workflows are provided below in relation to at least FIG. 3 and FIG. 4.

According to some embodiments, as discussed above, control engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102 and/or sensors 110. In some embodiments, such application may be a web-based application accessed by UE 102 and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on UE 102 and/or sensors 110.

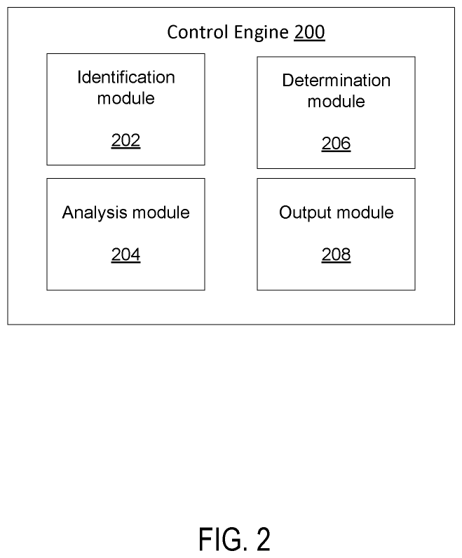

As illustrated in FIG. 2, according to some embodiments, control engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for the disclosed location management framework. According to some embodiments, Process 300 provides non-limiting embodiments for determining corresponding patterns of activity at a location; and as provided below, via Process 400 of FIG. 4, such patterns can be leveraged, via control engine 200, to control, manage and manipulate the operational status of a device (e.g., thermostat, appliances and the like) at the location.

According to some embodiments, Steps 302-304 of Process 300 can be performed by identification module 202 of control engine 200; Step 306 can be performed by analysis module 204; Step 308 can be performed by determination module 204; and Step 310 can be performed by output module 208.

According to some embodiments, Process 300 begins with Step 302 where a set of devices associated with a location are identified. According to some embodiments, the devices can be associated with any type of UE 102, sensors 110, and the like, discussed above in relation to FIG. 1. For example, the devices can at least include, but are not limited to, a user's smart phone, tablet devices in the home connected to the local network (e.g., Wi-Fi), televisions, routers/modems providing the network for the location, motion sensors, temperature sensors, door contacts, and the like. Additional, non-limiting examples of sensors and the types of collectable data are discussed above at least in relation to FIG. 1.

In some embodiments, the identified devices can be paired and/or connected with another device (e.g., sensor 110, engine 200 and/or UE 102) via a cloud and/or cloud-to-cloud (C2C) connection (e.g., establish connection with a third party cloud, which connects with cloud system 106, for example).

In Step 304, engine 200 can operate to trigger the identified devices to collect data about the location (e.g., referred to as sensor data). According to some embodiments, the sensor data can be collected continuously and/or according to a predetermined period of time or interval. In some embodiments, sensor data may be collected based on detected events. In some embodiments, type and/or quantity of sensor data may be directly tied to the type of device performing such data collection. For example, sudden changes in temperature or cloud cover, or the onset of precipitation can cause the sensor data to be collected, which can related to, but not limited to, a time, date, location, temperature(s), wind speed(s), precipitation amount(s), type of precipitation, duration of precipitation, cloud cover, types of clouds, and the like, or some combination thereof.

In some embodiments, such sensor data may be derived and/or mined from stored sensor data within an associated or third party cloud. For example, engine 200 can be associated with a cloud server/service, which can store collected sensor data for the location in an associated account of a user and/or the location. Thus, in some embodiments, Step 304 can involve querying the cloud for information about the location, which can be based on a criteria that can include, but is not limited to, a time, date, activity, event, other collected sensor data, and the like, or some combination thereof.

In some embodiments, the collected sensor data in Step 304 can be stored in database 108 in association with an identifier (ID) of a user, an ID of the device, an ID of the location and/or an ID of an account of the location (or user).

In Step 306, engine 200 can analyze the collected sensor data. According to some embodiments, engine 200 can implement any type of known or to be known computational analysis technique, algorithm, mechanism or technology to analyze the collected sensor data from Step 306.

In some embodiments, engine 200 may execute and/or include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the sensor data, as discussed herein.

According to some embodiments, the AI/ML computational analysis algorithms implemented can be applied and/or executed in a time-based manner, in that collected sensor data for specific time periods can be allocated to such time periods so as to determine patterns of activity (or non-activity) according to a criteria. For example, engine 200 can execute a Bayesian determination for a predetermined time span, at preset intervals (e.g., a 24 hour time span, every 8 hours, for example), so as to segment the day according to applicable patterns, which can be leveraged to determine, derive, extract or otherwise activities/non-activities in/around a location.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 308, based on the analysis from Step 306, engine 200 can determine a set of patterns for a user(s) and/or the location. According to some embodiments, the determined patterns are based on the computational AI/ML analysis performed via engine 200, as discussed above.

In some embodiments, the set of patterns can correspond to, but are not limited to, types of events, types of detected activity, a time of day, a date, type of user, duration, amount of activity, quantity of activities, sublocations outside/within the location (e.g., the garage, patio and/or rooms in the house, for example), and the like, or some combination thereof. Accordingly, the patterns can be specific to a user, a device (e.g., a thermometer on the back window of the house, for example), and/or specific to the location. Thus, according to some embodiments, Step 308 can involve engine 200 determining a set of real-world patterns that can correspond to a user(s), device(s) and/or the location.

In Step 310, engine 200 can store the determined set of patterns in database 108, in a similar manner as discussed above. According to some embodiments, Step 310 can involve creating a data structure associated with each determined pattern, whereby each data structure can be stored in a proper storage location associated with an identifier of the user/device/location, as discussed above.

In some embodiments, a pattern can comprise a set of events, which can correspond to an activity and/or non-activity (e.g., snow storm, clear skies, hail, hurricane, and the like, for example). In some embodiments, the pattern's data structure can be configured with header (or metadata) that identifies a user, device and/or the location, and/or a time period/interval of analysis (as discussed above); and the remaining portion of the structure providing the data of the activity/non-activity and status of entry-points during such sequence(s). In some embodiments, the data structure for a pattern can be relational, in that the events of a pattern can be sequentially ordered, and/or weighted so that the order corresponds to events with more or less activity.

In some embodiments, the structure of the data structure for a pattern can enable a more computationally efficient (e.g., faster) search of the pattern to determine if later detected events correspond to the events of the pattern, as discussed below in relation to at least Process 400 of FIG. 4. In some embodiments, the data structures of patterns can be, but are not limited to, files, arrays, lists, binary, heaps, hashes, tables, trees, and the like, and/or any other type of known or to be known tangible, storable digital asset, item and/or object.

According to some embodiments, the sensor data can be identified and analyzed in a raw format, whereby upon a determination of the pattern, the data can be compiled into refined data (e.g., a format capable of being stored in and read from database 108). Thus, in some embodiments, Step 310 can involve the creation and/or modification (e.g., transformation) of the sensor data into a storable format.

In some embodiments, as discussed below, each pattern (and corresponding data structure) can be modified based on further detected behavior, as discussed below in relation to Process 400 of FIG. 4.

Turning to FIG. 4, Process 400 provides non-limiting example embodiments for the deployment and/or implementation of the disclosed location management framework.

According to some embodiments, Steps 402 and 406 can be performed by identification module 202 of control engine 200; Step 404 can be performed by analysis module 204 and determination module 206; Step 408 can be performed by analysis module 204; Step 410 can be performed by determination module 206; and Steps 412 and 414 can be performed by output module 208.

According to some embodiments, Process 400 begins with Step 402 where engine 200 can monitor the location to detect, determine or otherwise identify activity related to a weather event. According to some embodiments, the weather event can correspond to, but not be limited to, the current weather, detected upcoming weather (e.g., decrease in barometric pressure, for example), and the like. For example, an event or weather event can correspond to the cloud cover at/around the location, current precipitation, humidity levels, barometric pressure, allergen levels (e.g., mold, oak, grass, ragweed, for example), wind direction and speed, air pressure, and the like, or some combination thereof.

By way of a non-limiting example, a security camera at a user's home can capture a set of image frames (e.g., a video clip) that captures a user approaching their home. In this footage, the weather can be analyzed, for which a weather event can be detected—for example: an approaching rain storm is identified from the frames of the video clip.

According to some embodiments, captured video clips can be analyzed via any of the known or to be known AI/ML models discussed above. For example, engine 200 can implement a computer vision model on captured video clips to determine weather events and/or event changes (e.g., sunny skies changing to cloud-covered, rain showers, for example).

In Step 404, engine 200 can determine or otherwise identify the attributes of the weather event. In some embodiments, the attributes can include, but are not limited to, a time, date, location, duration, type of weather, quantity of weather (e.g., how much rain), quality of weather (e.g., wind speed, speed of the storm, cloud movements, direction of wind, rain and/or clouds, and the like), and the like, or some combination thereof.

According to some embodiments, the determination/identification of the attributes of the weather event can be determined via analysis performed via any of the known or to be known AI/ML models discussed above. In some embodiments, the identification of the attributes can additionally or alternatively be based on engine 200 pinging, polling or signaling the devices or sensors (as discussed above respective FIG. 1) at the location, and/or third party data (e.g., from a weather forecasting application), and collecting data related to the current weather.

In some embodiments, processing steps of Process 400 can proceed from Step 404 to Step 406 then to Step 408; and in some embodiments, Process 400 can proceed from Step 404 to Step 408 (e.g., bypassing Step 406, whereby learned patterns may not be utilized).

Accordingly, in some embodiments, Step 406 can involve engine 200 performing a search of database 108, whereby the search can be based on a query compiled from data associated with the attributes of the event. In some embodiments, such attributes can enable engine 200 to identify stored behavior patterns or preferences of devices, sensors and/or other components (e.g., windows, blinds, doors, and the like) that correspond to known activities at the location, at certain times. For example, if the attributes of the event indicate a rain event at night, then a stored behavior pattern/preference(s) of nighttime location configurations can be retrieved (e.g., which windows are open at night, which doors unlocked, blinds open, and the like). Thus, patterns/preferences for similarly related events, as per a similarly threshold being satisfied from a similarity analysis via any of the AI/ML models, can be retrieved from database 108.

In Step 408, engine 200 can analyze the attributes of the event, which can be based on the retrieved stored behavior pattern/preferences; and in Step 410, engine 200 can determine a configuration for the location based on such analysis. As discussed herein, the configuration includes a set-up of the real-world (and/or digital) components at the location that secure the location against the attributes of the weather event (e.g., close windows, turn off electronics, change modes of thermostat, arm security system, and the like). In some embodiments, the analysis in Step 408 can additionally and/or alternatively be based on user preferences for the location, which may be provided by a user and/or from the stored behavior patterns. And, in some embodiments, the analysis in Step 408 can be based on, either additionally or alternatively, current configurations of the location.

According to some embodiments, the configuration determination of the location can be performed via any of the known or to be known AI/ML models discussed above.

By way of a non-limiting example, engine 200 can determine that since the windows are generally open at night, engine 200 can determine that for a particular rain event, as currently occurring, only the shades or blinds need to be closed for such windows. In some embodiments, such determination may not require learned behaviors; however, in some embodiments, engine 200's implementation and utilization of learned patterns can increase how efficiently and accurately engine 200 can determine which components of the location are currently exposed during a weather event. Moreover, patterns can more readily and resource-efficiently be adjusted in a real-time manner, thereby enabling a predictive and dynamically configured control mechanisms for implementation within location monitoring systems.

According to some embodiments, such determined configurations can include engaging, modifying statuses (from an initial or current status to an updated/modified status) and/or opening/closing components associated with entry points of a location, security systems and/or control systems of the location, water, power, and the like. For example, water can be shut off; power diverted from certain zones in the location; emergency calls triggered based on detected events (e.g., storm surge from the ocean being detected as approaching the coastal-located home); and the like, or some combination thereof.

In Step 412, engine 200 can generate controls and/or electronic instructions for implementing the configuration determined in Step 410. Such controls/instructions can include automated steps to be performed by components of the location monitoring system(s) and/or notifications to the user or other users as to the current and/or impending weather event. For example, engine 200 can engage automated controls to close windows, lock doors, draw blinds, and the like. In another example, engine 200 can engage a large language model (LLM) to communicate with a user to alert them as to their options based on the attributes of the impending weather event (e.g., flee, hunker down, move to higher ground, shut off power, close windows, contact authorities for aid, and the like); whereby upon receiving instructions in response to certain prompts, can automatically act accordingly. And, in another non-limiting example, the controls can include a notification (e.g., SMS) being sent to the user, which can alert them to the current configuration of the location, the weather event, and the determined configurations, which can be provided as a recommendation.

And, in Step 414, engine 200 can automatically execute the controls/instructions generated/compiled in Step 412, thereby modifying components of the location to adapt to the attributes of the location.

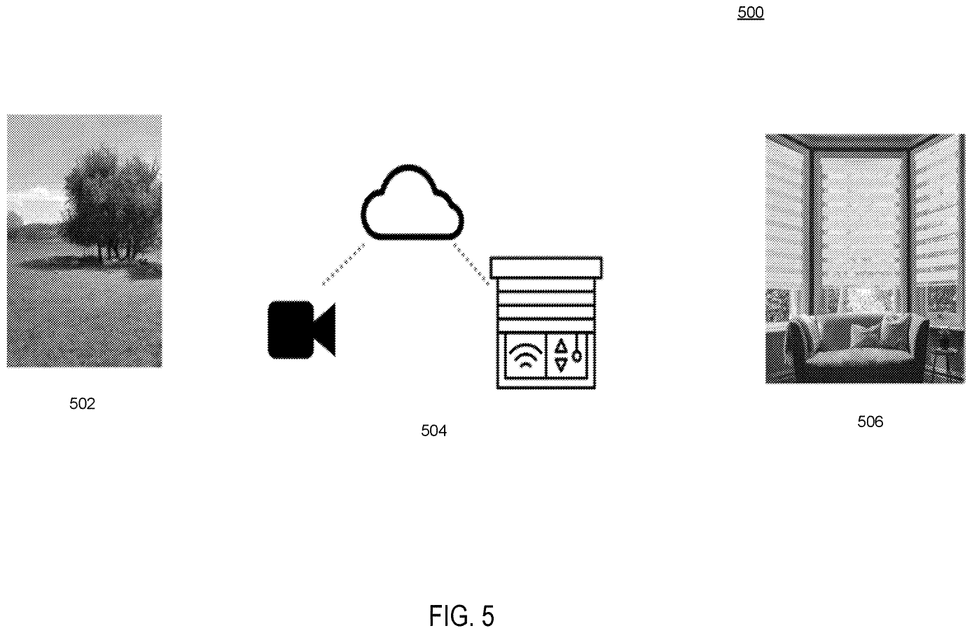

Turning to FIG. 5, by way of a non-limiting example 500, according to some embodiments, depicted is a sequence of events 502, 504 and 506. During a clear, sunny day, as in 502, engine 200, via a camera (e.g., sensor 110, for example), can detect that the sun is shining, yet the windows of the home are opened. Based on preferences of the user and/or past behavior at the location, during sunny days, the window blinds are typically drawn/closed (as in 504); therefore, as in 506, engine 200 can cause the windows to be drawn/closed (e.g., as in Steps 410-414, discussed supra).

Thus, turning back to Process 400, provided in collaboration with the processing of Process 300 is a computerized location monitoring framework that can detect, via collected sensor data, upcoming and/or current weather-related events, and proactively execute operations that configure, modify and/or secure the location against dangers associated with such events.

FIG. 8 is a schematic diagram illustrating a client device showing an example embodiment of a client device that may be used within the present disclosure. Client device 800 may include many more or less components than those shown in FIG. 8. However, the components shown are sufficient to disclose an illustrative embodiment for implementing the present disclosure. Client device 800 may represent, for example, UE 102 discussed above at least in relation to FIG. 1.

As shown in the figure, in some embodiments, Client device 800 includes a processing unit (CPU) 822 in communication with a mass memory 830 via a bus 824. Client device 800 also includes a power supply 826, one or more network interfaces 850, an audio interface 852, a display 854, a keypad 856, an illuminator 858, an input/output interface 860, a haptic interface 862, an optional global positioning systems (GPS) receiver 864 and a camera(s) or other optical, thermal or electromagnetic sensors 866. Device 800 can include one camera/sensor 866, or a plurality of cameras/sensors 866, as understood by those of skill in the art. Power supply 826 provides power to Client device 800.

Client device 800 may optionally communicate with a base station (not shown), or directly with another computing device. In some embodiments, network interface 850 is sometimes known as a transceiver, transceiving device, or network interface card (NIC).

Audio interface 852 is arranged to produce and receive audio signals such as the sound of a human voice in some embodiments. Display 854 may be a liquid crystal display (LCD), gas plasma, light emitting diode (LED), or any other type of display used with a computing device. Display 854 may also include a touch sensitive screen arranged to receive input from an object such as a stylus or a digit from a human hand.

Keypad 856 may include any input device arranged to receive input from a user. Illuminator 858 may provide a status indication and/or provide light.

Client device 800 also includes input/output interface 860 for communicating with external. Input/output interface 860 can utilize one or more communication technologies, such as USB, infrared, Bluetooth™, or the like in some embodiments. Haptic interface 862 is arranged to provide tactile feedback to a user of the client device.

Optional GPS transceiver 864 can determine the physical coordinates of Client device 800 on the surface of the Earth, which typically outputs a location as latitude and longitude values. GPS transceiver 864 can also employ other geo-positioning mechanisms, including, but not limited to, triangulation, assisted GPS (AGPS), E-OTD, CI, SAI, ETA, BSS or the like, to further determine the physical location of client device 800 on the surface of the Earth. In one embodiment, however, Client device 800 may through other components, provide other information that may be employed to determine a physical location of the device, including for example, a MAC address, Internet Protocol (IP) address, or the like.

Mass memory 830 includes a RAM 832, a ROM 834, and other storage means. Mass memory 830 illustrates another example of computer storage media for storage of information such as computer readable instructions, data structures, program modules or other data. Mass memory 830 stores a basic input/output system (“BIOS”) 840 for controlling low-level operation of Client device 800. The mass memory also stores an operating system 841 for controlling the operation of Client device 800.

Memory 830 further includes one or more data stores, which can be utilized by Client device 800 to store, among other things, applications 842 and/or other information or data. For example, data stores may be employed to store information that describes various capabilities of Client device 800. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 800.

Applications 842 may include computer executable instructions which, when executed by Client device 800, transmit, receive, and/or otherwise process audio, video, images, and enable telecommunication with a server and/or another user of another client device. Applications 842 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by a device associated with a control system, a video clip comprising content corresponding to a weather event at a location;
analyzing, by the device, the video clip via execution of a computer vision artificial intelligence/machine learning (AI/ML) model, and determining attributes of the weather event from the video clip;
identifying, by the device, a set of devices associated with the location;
collecting sensor data from each of the set of devices associated with the location;
analyzing, via the device, the sensor data to determine a set of learned patterns of activity for the location, wherein the set of learned patterns correspond to historical configurations of the location at one or more prior time periods;
storing, in a database, the set of learned patterns of activity;
identifying, by the device, a set of preferences for the location based on the attributes of the weather event, wherein the set of preferences is retrieved from the stored set of learned patterns of activity corresponding to previous configurations of the location for similarly related weather events;
analyzing, by the device, the attributes of the event based on the set of preferences;
determining, by the device, based on the analysis of the set of attributes, a configuration for the location, the configuration comprising a set-up of components at the location that secure the location against the attributes of the weather event; and
controlling, by the device, the components of the location based on the determined configuration.

2. The method of claim 1, further comprising:
generating, based on the determined configuration, a set of electronic controls for at least a portion of the components at the location; and
executing the set of electronic controls, wherein the control of the components is performed via the execution of the set of electronic controls.

3. The method of claim 1, wherein the control of the components of the location comprises a modification from an initial status to an updated status, the updated status being in a configuration that adapts to the attributes of the weather event.

4. The method of claim 1, wherein the analysis of the attributes of the event is further based on a current configuration of the location.

5. The method of claim 1, wherein the attributes of the weather event correspond to at least one of a time, date, location, duration, type of weather, quantity of weather, and quality of weather.

6. The method of claim 1, wherein analyzing the sensor data to determine the set of learned patterns of activity comprises executing at least one of a convolutional neural network (CNN), a recurrent neural network (RNN), an XGBoost regression algorithm, a Bayesian determination, or a support vector machine (SVM) model on the sensor data collected from the set of devices.

7. The method of claim 1, further comprising:
monitoring, by the device, the location; and
capturing event data corresponding to the weather event, wherein the identification of the weather event is based on the captured event data.

8. The method of claim 7, wherein the device is a camera associated with the control system.

9. The method of claim 1, wherein the control system is at least one of a security system and climate system configured to control real-world attributes at the location.

10. The method of claim 1, wherein the analysis of the attributes of the event is performed via execution of at least one of an artificial intelligence and machine learning algorithm.

11. A system comprising:
a processor associated with a control system configured to:
identify a video clip comprising content corresponding to a weather event at a location;
analyze the video clip via execution of a computer vision artificial intelligence/machine learning (AI/ML) model, and determine attributes of the weather event from the video clip;
identify a set of devices associated with the location;
collect sensor data from each of the set of devices associated with the location;
analyze the sensor data to determine a set of learned patterns of activity for the location, wherein the set of learned patterns correspond to historical configurations of the location at one or more prior time periods;
store, in a database, the set of learned patterns of activity;
identify a set of preferences for the location based on the attributes of the weather event, wherein the set of preferences is retrieved from the stored set of learned patterns of activity corresponding to previous configurations of the location for similarly related weather events;
analyze the attributes of the event based on the set of preferences;
determine, based on the analysis of the set of attributes, a configuration for the location, the configuration comprising a set-up of components at the location that secure the location against the attributes of the weather event; and
control the components of the location based on the determined configuration.

12. The system of claim 11, wherein the processor is further configured to:
generate, based on the determined configuration, a set of electronic controls for at least a portion of the components at the location; and
execute the set of electronic controls, wherein the control of the components is performed via the execution of the set of electronic controls.

13. The system of claim 11, wherein the control of the components of the location comprises a modification from an initial status to an updated status, the updated status being in a configuration that adapts to the attributes of the weather event.

14. The system of claim 11, wherein the analysis of the attributes of the event is further based on a current configuration of the location.

15. The system of claim 11, wherein to analyze the sensor data to determine the set of learned patterns of activity, the processor is further configured to execute at least one of a convolutional neural network (CNN), a recurrent neural network (RNN), an XGBoost regression algorithm, a Bayesian determination, or a support vector machine (SVM) model on the sensor data collected from the set of devices.

16. A non-transitory computer-readable storage medium tangibly encoded with computer-executable instructions that when executed by a device, perform a method comprising:
identifying, by the device associated with a control system, a video clip comprising content corresponding to a weather event at a location;
analyzing, by the device, the video clip via execution of a computer vision artificial intelligence/machine learning (AI/ML) model, and determining attributes of the weather event from the video clip;
identifying, by the device, a set of devices associated with the location;
collecting sensor data from each of the set of devices associated with the location;
analyzing, by the device, the sensor data to determine a set of learned patterns of activity for the location, wherein the set of learned patterns correspond to historical configurations of the location at one or more prior time periods;
storing, in a database, the set of learned patterns of activity;
identifying, by the device, a set of preferences for the location based on the attributes of the weather event, wherein the set of preferences is retrieved from the stored set of learned patterns of activity corresponding to previous configurations of the location for similarly related weather events;
analyzing, by the device, the attributes of the event based on the set of preferences;
determining, by the device, based on the analysis of the set of attributes, a configuration for the location, the configuration comprising a set-up of components at the location that secure the location against the attributes of the weather event; and
controlling, by the device, the components of the location based on the determined configuration.

17. The non-transitory computer-readable storage medium of claim 16, further comprising:
generating, based on the determined configuration, a set of electronic controls for at least a portion of the components at the location; and
executing the set of electronic controls, wherein the control of the components is performed via the execution of the set of electronic controls.

18. The non-transitory computer-readable storage medium of claim 16, wherein the control of the components of the location comprises a modification from an initial status to an updated status, the updated status being in a configuration that adapts to the attributes of the weather event.

19. The non-transitory computer-readable storage medium of claim 16, wherein the analysis of the attributes of the event is further based on a current configuration of the location.

20. The non-transitory computer-readable storage medium of claim 16, wherein analyzing the sensor data to determine the set of learned patterns of activity comprises executing at least one of a convolutional neural network (CNN), a recurrent neural network (RNN), an XGBoost regression algorithm, a Bayesian determination, or a support vector machine (SVM) model on the sensor data collected from the set of devices.
